(19) United States
(12) Patent Application Publication
(10) Pub. No.: US 2025/0319843 A1
(43) Pub. Date: Oct. 16, 2025

(54) Method for Signaling a Communication State for a Motor Vehicle, Motor Vehicle and System

(71) Applicant: Bayerische Motoren Werke Aktiengesellschaft, Muenchen (DE)

(72) Inventors: Stefan DIEWALD, Moosburg a.d. Isar (DE); Thomas WURSTHORN, Muenchen (DE)

(21) Appl. No.: 19/077,819

(22) Filed: Mar. 12, 2025

(30) Foreign Application Priority Data
Apr. 12, 2024 (DE) 10 2024 110 393.0

(51) Int. Cl. B60R 25/24; B60R 25/04

(52) U.S. Cl. CPC B60R 25/24; B60R 25/04; B60R 2325/101

(57) ABSTRACT

A method for signaling a communication state for a motor vehicle. The motor vehicle comprises a control device and a communication device. The control device is configured to communicate with a mobile device via the communication device. The mobile device has an authenticated digital key valid for the motor vehicle. The method is performed by the control device. The method includes receiving a first signal from the mobile device via the communication device indicating a remote control key event. The method includes causing a start of an execution of a function associated with the remote control key event on the motor vehicle. The method includes sending a second signal to the mobile device, when the execution of the function continues for a period of time longer than a predetermined period of time, to signal that the execution of the instruction is continuing.

### CROSS REFERENCE TO RELATED APPLICATION

This application claims priority under 35 U.S.C. § 119 from German Patent Application No. 10 2024 110 393.0, filed Apr. 12, 2024, the entire disclosure of which is herein expressly incorporated by reference.

### BACKGROUND AND SUMMARY OF THE INVENTION

The invention relates to a method for signaling a communication state for a motor vehicle, a motor vehicle comprising a communication device and a control device, and a system formed of a motor vehicle and a mobile device.

Communicative connections between a vehicle and a mobile device are known in the prior art. For example, a wired or wireless communication connection can be used to initiate and control vehicle functions via the mobile device. For this purpose, the “Digital Key Release 3” standard of the Car Connectivity Consortium (https://carconnectivity.org/) in version 1.2.2 describes the possibility of sending a message from the mobile device to a motor vehicle in order to query the execution status of a function on the motor vehicle. For example, it is possible for the motor vehicle to report back that the function has been successfully executed, that an execution has been started, that an execution has been successfully stopped, that an execution is completed, that an execution is not possible or has been revoked, that an execution is not possible due to a vehicle state, that an authentication error is displayed, that a waiting time or a time limit (timeout) has expired, that the function has been stopped, that the vehicle is outside the execution area and the like. Furthermore, a confirmation for an ongoing RKE process (so-called “remote key event” process) can be requested, which can be reported back if the RKE process is currently being executed.

However, if a long-lasting process is to be carried out that requires a time that is longer than a time limit for reporting back a status message, a remote key event may be canceled unintentionally. A long-lasting process can be a process that takes several seconds, for example, but requires a longer time than the aforementioned time limit.

To this end, publication WO 2019/158 157 A1 discloses, for example, a master-slave system for communication via a Bluetooth low-energy connection. The master-slave system has at least one slave device and at least one master device, wherein the slave device and the master device are set up to communicate via the Bluetooth low-energy connection. However, the publication does not take into account the case of a high processing load or the case of a long-lasting process.

Furthermore, DE 10 2022 109 633 A1 discloses a system and method for the interactive control of vehicle functions. The system comprises a vehicle and a smart device. The smart device is set up to establish a communicative connection with the vehicle. The vehicle is set up to determine a trigger event in the vehicle, wherein the determination of the trigger event comprises the evaluation of sensor data in the vehicle. When the trigger event is determined by the vehicle, the vehicle is set up to transmit a trigger data set to the smart device. After receiving the trigger data set, the smart device is set up to interact with the vehicle in accordance with the trigger data set. The interaction of the smart device with the vehicle may comprise controlling at least one vehicle function of the vehicle. However, this document also fails to consider the case of a high processing load or the case of a long-lasting process.

It is an object of the invention to improve this situation and to provide a solution to the above-mentioned problems. According to the invention, this object is achieved by a method for signaling a communication state for a motor vehicle described herein.

In particular, the invention provides a method for signaling a communication state for a motor vehicle, wherein the motor vehicle comprises a control device and a communication device for wireless communication with a mobile device, wherein the control device is set up to communicate with the mobile device, for example via Bluetooth or Bluetooth Low Energy, by means of the communication device. The mobile device has a digital key that is valid for the motor vehicle and is authenticated by the motor vehicle. This means that the mobile device is within radio range of the motor vehicle and is able to control a vehicle function on the motor vehicle or the motor vehicle is able to execute the function that the mobile device has instructed.

The control device is set up to perform the following steps in the course of the method. First, a first signal is received from the mobile device by means of the communication device, wherein the first signal indicates a remote key event. This can be used to execute a function on the motor vehicle or to obtain status information from the motor vehicle. If, for example, a user makes an input on the mobile device in order to execute a corresponding instruction on the motor vehicle, the mobile device sends the first signal to the motor vehicle in order to initiate the execution of a function on the motor vehicle that is assigned to the remote key event. The motor vehicle or the control device of the motor vehicle is set up to send a second signal to the mobile device if the execution of the function lasts for a period of time that is longer than a predefined period of time. In this case, the second signal serves to indicate that the execution of the instruction or the function assigned to the remote control key event on the motor vehicle is taking a long time. This second signal can be used to prevent the specified duration (or time limit) from being exceeded on the mobile device and the execution of the function assigned to the remote control key event on the motor vehicle from being aborted.

For example, the time limit for a remote control key event can be set to a few seconds, such as one second. The time limit may be a default value or may have been transmitted to the vehicle in advance by the mobile device. If, for example, a user requests a remote control key event via the mobile device that opens the luggage compartment and the execution of the luggage compartment opening is expected to take longer than the aforementioned time limit of one second, it is possible for the motor vehicle to send a second signal to the mobile device that signals that the execution of the luggage compartment opening will take longer than the time limit of one second. In this way, the connection between the mobile device and the motor vehicle can be maintained, the time limit on the mobile device can be reset or extended, or a new time limit can be started. The motor vehicle can be set up to estimate an execution time for the function and send out the first signal based on this, and/or can be set up to send out the first signal at a predetermined time or, for example, a time transmitted by the mobile device that is shorter than the time limit on the mobile device.

Due to a high processing load on the vehicle, the opening of the luggage compartment may take longer than the aforementioned time limit of one second, for example. After the remote key event has been received by the vehicle, the vehicle can, for example, send the second signal indicating the ongoing state of the execution of the instruction (so-called pending status) to the mobile device at intervals of, for example, every 0.5 s until the luggage compartment lid is fully opened and the execution of the luggage compartment opening is completed. Furthermore, a remote control key event can last for a longer period of time, for example, because another remote control key event function is currently being performed on the vehicle. If several remote control key event functions are performed in this way, it may be easier for a time limit for one of these remote control key event functions to be exceeded and thus for one or more remote control key event functions to be aborted.

In the aforementioned CCC standard for the digital key, there is no state for the remote control key event protocol that defines a pending status for remote control key event requests. Furthermore, individual devices in the vehicle may additionally set respective predetermined time durations individually, so that individual timeouts can easily occur. In this way, sending the second signal to the mobile device ensures that no timeout occurs on the mobile device or on the motor vehicle.

The invention comprises further advantageous embodiments, which are described below.

According to a further advantageous embodiment, it is provided that the motor vehicle transmits a third signal to the mobile device when the execution of the function is completed. For example, the motor vehicle can repeat the transmission of the second signal to the mobile device until the execution of the function assigned to the remote control key event on the motor vehicle is completed. If the function is completed, the motor vehicle can send a third signal to the mobile device to signal that the execution of the function has been completed. This allows the process to be completed on the mobile device. This can be used to indicate to the user that the function is completed and the final state has been reached, or that the execution of the function has failed, for example.

According to a further advantageous embodiment, it is provided that the mobile device requests feedback from the motor vehicle at regular time intervals until the execution of the function has been completed. In other words, the mobile device can be set up to regularly request from the motor vehicle whether the execution of the function has been completed. In this case, the motor vehicle can additionally send back the second signal for each request until the execution of the function is completed. This embodiment represents an advantageous embodiment of the invention and ensures in particular that the execution of the function is not terminated by a time limit being exceeded.

According to a further advantageous embodiment, it is provided that the motor vehicle sends a feedback signal back to the mobile device at regular intervals until the execution of the assigned function on the motor vehicle is completed. In other words, the motor vehicle can, for example, send the second signal back to the mobile device on its own initiative in order to signal to the mobile device that the execution of the function assigned to the remote control key event on the motor vehicle has not yet been completed. If the execution of the assigned function is completed, the aforementioned third signal can also be sent to the mobile device, for example. By means of this embodiment, it is simply possible to implement the invention and, by sending the second signal to the motor vehicle, to maintain the connection between the motor vehicle and the mobile device and to signal to the mobile device in a simple manner that the execution of the assigned function on the motor vehicle is not yet completed.

According to a further advantageous embodiment, it is provided that the communication between the motor vehicle and the mobile device takes place via a Bluetooth protocol, in particular via Bluetooth Low Energy. This configuration has the advantage that communication with the mobile device that houses the digital key is possible in a simple manner. This makes it possible to implement an interaction between the vehicle and the mobile device in a very flexible and simple way, without the need for additional intervention by the user of the vehicle.

Bluetooth Low Energy is a radio technology that enables communication between two communication participants in a close environment, for example ten meters, 50 meters, 100 meters, 500 meters, in a way known from the prior art. Bluetooth Low Energy technology has a very low power consumption compared to classic Bluetooth.

Preferably, the vehicle and the mobile device each comprise a communication unit, wherein the vehicle and the mobile device are set up to establish a connection with each other using Bluetooth Low Energy (BLE).

According to a further advantageous embodiment, it is provided that the function assigned to the remote control key event is starting the air conditioning system of the motor vehicle and/or starting the engine of the motor vehicle. With these functions, it can easily occur that the execution of the function lasts longer than a predetermined period of time, so that it is particularly easy for a time limit to be exceeded or a timeout to occur with this function. This design makes it easy to ensure that the assigned function is executed correctly and/or completely. With these functions, the transmission of the second signal from the motor vehicle to the mobile device is also particularly advantageous in order to ensure that the respective function is carried out completely.

According to a further advantageous embodiment, it is provided that the function associated with the remote control key event is an opening or closing of the windows of the motor vehicle. In other words, opening or closing the windows may be a function that requires a long time, and thus it is easily possible that a timeout may occur after an instruction of the function associated with the remote control key event. Thus, this embodiment represents a particularly advantageous embodiment of the technology disclosed herein.

According to a further advantageous embodiment, it is provided that the function assigned to the remote control key event is a vehicle function in which a delayed response from the vehicle can occur due to referencing phases, diagnostic sequences and/or start times when exiting energy-saving modes. With these functions, a timeout can easily occur after the assigned function has been instructed. For example, an energy-saving mode may require parts of a central control unit to be switched off temporarily in order to reduce the vehicle's energy consumption. If certain vehicle functions are requested, it may be necessary to perform certain start-up and diagnostic sequences to ensure proper operation of the control unit. However, these sequences may require a period of time that can result in a timeout for communication with the digital key device or mobile device after the assigned function has been instructed. Thus, this embodiment represents a particularly advantageous embodiment of the technology disclosed herein.

According to a further aspect of the presently disclosed technology, a motor vehicle is provided with a communication device and a control device, wherein the motor vehicle is designed to perform the method as described above

According to a further aspect of the technology disclosed herein, there is provided a system formed of the above-described motor vehicle and a mobile device, wherein the motor vehicle comprises a control device and a communication device, wherein the control device is set up to communicate with a mobile device by means of the communication device, wherein the mobile device has an authenticated digital key valid for the motor vehicle and is set up to interact with the motor vehicle, and wherein the motor vehicle and the mobile device are both set up to perform the method as described above.

Further features of the invention can be found in the claims, the figures and the description of the figures. The features and combinations of features mentioned above in the description as well as the features and combinations of features mentioned below in the description of the figures and/or shown alone in the figures can be used not only in the combination indicated in each case, but also in other combinations or on their own.

Other objects, advantages and novel features of the present invention will become apparent from the following detailed description of one or more preferred embodiments when considered in conjunction with the accompanying drawings.

The invention will now be explained in greater detail with reference to a particularly preferred embodiment and with reference to the drawings.

### BRIEF DESCRIPTION OF THE DRAWINGS

FIG. 1 shows a schematic representation of a motor vehicle and a mobile device;

FIG. 2 shows a schematic representation of a communication method; and

FIG. 3 shows a schematic flow chart of a method.

### DETAILED DESCRIPTION OF THE DRAWINGS

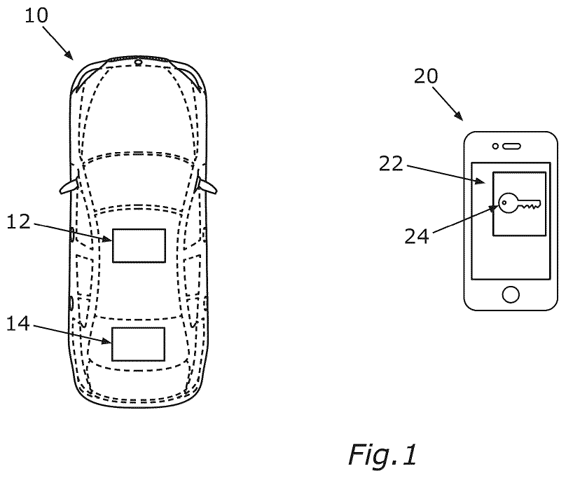

FIG. 1 schematically shows a motor vehicle 10 with a control device 12. The motor vehicle 10 also has a communication device 14. The control device 12 can send or receive signals to a mobile device 20 via the communication device from the motor vehicle 10 to the mobile device 20. An application 22 is provided on the mobile device 20 and comprises a digital key. The motor vehicle 10 is designed to carry out the method as described above. The mobile device has a valid authenticated digital key 24 and is set up to interact with the motor vehicle. Both the motor vehicle and the mobile device are set up to perform the method described above. For example, remote control key events such as unlocking or locking the vehicle, starting a prime mover, coupling the owner's key to the vehicle, recalling the digital key, sharing a friend key, rights restrictions or rights extensions for a digital key, starting or stopping an air conditioning function, opening or closing windows of the motor vehicle or even just tracking an issued digital key for insurance purposes can be performed on the motor vehicle 10 as instructed by the mobile device 20. If the mobile device 20 sends a request or a remote key event to the motor vehicle 10 in the event of a remote key event with a digital key 24, for example via Bluetooth, in order to execute a function on the motor vehicle 10, the mobile device 20 sends such a request to the motor vehicle 10. The vehicle can authenticate the key or the key can already be authenticated in advance, and the motor vehicle 10 then executes the instruction by executing or starting the function assigned to the remote key event. If the function is completed, the motor vehicle 10 returns a response within a preset time limit and signals the success or failure of the execution of the assigned vehicle function. Further examples of vehicle functions are light or alarm functions, lowering or raising air springs, charge control in an electric vehicle, opening or closing a fuel filler flap, locking the vehicle and switching on an alarm function, controlling the windows and the like. However, if an event occurs during one of these executions of these functions that forces a timeout to occur, the motor vehicle 10 is set up to send a second signal back to the mobile device 20, which signals to the mobile device that the execution of the motor vehicle function associated with the remote control key event is still ongoing. In this way, the time limit or time restriction can be extended to ensure successful execution of the function. If the execution of the function is completed, a further or third signal can be sent to the mobile device 20 to signal that the execution of the function is completed. The second or third signal or the entire communication can be sent via Bluetooth or Bluetooth LE, but also via WIFI, via an IP connection or via UWB.

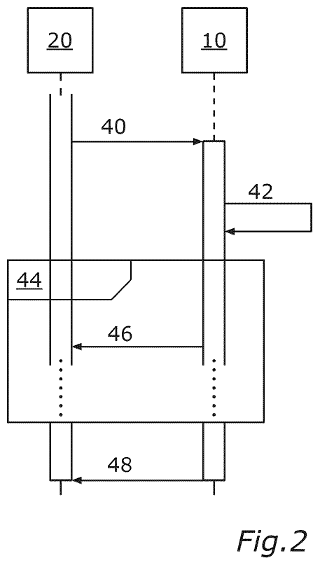

FIG. 2 schematically shows a communication sequence between a mobile device 20 and a motor vehicle 10. A time sequence is plotted progressing downwards in a vertical direction. At a first point in time, a signal 40 is transmitted by the mobile device 20, which indicates a remote key event (RKE) to the motor vehicle 10. After receiving the signal, the function is started on the motor vehicle 10 (indicated by the reference sign 42). A loop structure is indicated by the reference sign 44, wherein the loop can be repeated as often as required until the execution of the function is completed. At a second point in time, which is preferably before the time limit on the mobile device (or the actuator or control unit on the motor vehicle 10 executing the function) has expired, the motor vehicle 10 sends a second signal 46 back to the mobile device 20, which indicates to the mobile device 20 that the execution of the function is continuing for a period of time which is longer than a predetermined period of time and thus signals that the execution of the instruction is continuing. At a third point in time, the motor vehicle 10 can send a message back to the mobile device 20 that the execution of the function is completed. Here, the signal 46 corresponds to the second signal and the signal 48 corresponds to the third signal.

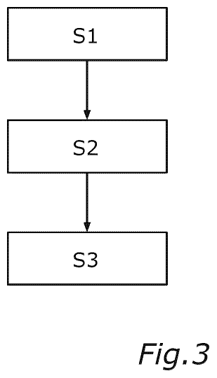

FIG. 3 schematically shows a flow chart of the method according to the presently disclosed technology. In a step S1, a first signal 40 is received by the mobile device 20 from the communication device 14 of the motor vehicle 10, indicating a remote key event. In a step S2, the control device 12 on the motor vehicle initiates an execution of a function associated with the remote key event on the motor vehicle 10. In a step S3, the motor vehicle 10 sends a second signal 46 back to the mobile device 20 if the execution of the function continues for a period of time that is longer than a predetermined period of time to signal that the execution of the instruction is continuing. This step, and thus the sending of the second signal to the mobile device 20, can be repeated by the control device 12 of the motor vehicle 10 as often as necessary until the execution of the instruction is completed. In a step S4, not shown, the motor vehicle 10 can also send a third signal 46 back to the mobile device 20 if the execution of the function is finally completed.

A particularly preferred exemplary embodiment is also described below.

The current definition of the Remote Key Event protocol (RKE protocol) in the CCC digital key standard does not include a “pending” status message to describe a status of an ongoing execution of a function in response to an RKE request. The current CCC digital key standard does not describe a time limit for RKE requests for vehicle devices. This means that each device can set its own time limit for RKE requests. This does not take into account processing times for different RKE requests on the motor vehicle.

If a device sets a rigid or strict time limit for an RKS request, it can happen, for example, that an RKE function is currently being executed on the motor vehicle, but a respective time limit has already been exceeded on the mobile device and thus an RKE function is marked as canceled.

If the motor vehicle receives an RKE request, for example via Bluetooth or Bluetooth Low Energy, the motor vehicle should be given the option of reporting back to the mobile device that the processing of the RKE request requires more time by the motor vehicle reporting back to the mobile device the “pending” operating status (“pending” status). The motor vehicle can repeat the transmission of the pending status to the mobile device as long as the execution of the RKE request continues.

For example, if the mobile device defines a general time limit for executing an RKE request of 3 seconds, for example, the user may request the opening of a luggage compartment as an RKE request. In this case, the mobile device sends the RKE request to the vehicle and starts the 3-second period. The vehicle authenticates the digital key, or the digital key is already authenticated, and then executes the function requested by the RKE request (or executes the command). Upon completion of the execution of the function, the vehicle returns a response within the preset time limit and signals the success or failure of the function.

For example, if the luggage compartment takes longer than 3 seconds to open due to a high processing load on the vehicle, the mobile device may determine that the RKE request has failed because the time limit has been exceeded. Therefore, after receiving the RKE request, the vehicle may send the “pending” status back to the mobile device every 1 second until the luggage compartment is opened.

Examples of functions include light functions, alarm functions, lowering air springs, charge control for electric vehicles, opening or closing a fuel filler flap, locking and securing the vehicle (“Lock and Secure”), and controlling the windows

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 motor vehicle
12 control device
14 communication device
20 mobile device 22 application
24 digital key
40 first signal
42 start executing the function
44 loop
46 second signal
48 third signal

What is claimed is:

1. A method for signaling a communication state for a motor vehicle, wherein the motor vehicle comprises a control device and a communication device, wherein the control device is configured to communicate with a mobile device via the communication device, wherein the mobile device has an authenticated digital key valid for the motor vehicle, and wherein the method is performed by the control device and comprises:
receiving a first signal from the mobile device via the communication device indicating a remote control key event;
causing a start of an execution of a function associated with the remote control key event on the motor vehicle; and
sending a second signal to the mobile device, when the execution of the function continues for a period of time longer than a predetermined period of time, to signal that the execution of the instruction is continuing.

2. The method of claim 1, wherein the motor vehicle transmits a third signal to the mobile device when the execution of the function is completed.

3. The method of claim 1, wherein the mobile device requests feedback from the motor vehicle at regular time intervals until the execution of the function is completed.

4. The method of claim 1, wherein the motor vehicle sends a feedback message back to the mobile device at regular intervals until the execution of the assigned function on the motor vehicle is completed.

5. The method of claim 1, wherein the communication between the motor vehicle and the mobile device takes place via a Bluetooth protocol.

6. The method of claim 1, wherein the function associated with the remote control key event is a starting of the air conditioning system of the motor vehicle and/or a starting of the engine of the motor vehicle.

7. The method of claim 1, wherein the function associated with the remote control key event is an opening or closing of the windows of the motor vehicle.

8. The method of claim 1, wherein the function associated with the remote control key event is a vehicle function in which a delayed response of the vehicle may occur due to referencing phases, diagnostic sequences and/or start times when exiting energy saving modes.

9. A motor vehicle, comprising:
a control device; and
a communication device configured to carry out the method of claim 1.

10. A system, comprising:
a mobile device; and
a motor vehicle comprising:
a communication device, and
a control device, wherein the control device is configured for communication with the mobile device via the communication device,
wherein the mobile device has an authenticated digital key valid for the motor vehicle and is configured to interact with the motor vehicle, and
wherein the motor vehicle and the mobile device are each configured to perform the method of claim 1.
